(19) United States
(12) Patent Application Publication
(10) Pub. No.: US 2005/0137744 A1
(43) Pub. Date: Jun. 23, 2005

(54) Method and apparatus for product separation and processing

(75) Inventors: Antoine J. H. Winkelmolen, Shawnee, KS (US); Ralph A. Miller, Parkville, MO (US)

Correspondence Address: SPENCER, FANE, BRITT & BROWNE, 1000 WALNUT STREET, SUITE 1400, KANSAS CITY, MO, 64106-2140, US

(73) Assignee: Johnson Food Equipment, Inc.

(21) Appl. No.: 11/017,983

(22) Filed: Dec. 20, 2004

Related U.S. Application Data
(60) Provisional application No. 60/531,474, filed on Dec. 19, 2003.

(51) Int. Cl. G06F 17/00

(52) U.S. Cl. 700/223

(57) ABSTRACT

A method and apparatus for product separation and processing are provided where an apparatus for sorting and grouping objects includes: an attribute measurement device 20; a first conveyor 18 moving at a first rate of speed; a second conveyor 26 oriented perpendicularly to the first conveyor 18 and moving at a second rate of speed which is less than the first rate of speed; a position determination device 30; and a controller unit 22 that groups sets of objects 16 matching a target attribute based on attribute measurements and position information from a population of objects 28.

### CROSS REFERENCE TO RELATED APPLICATIONS

This application claims priority, and fully incorporates herein by reference, U.S. Provisional Application Ser. No. 60/531,474, entitled “Product Separation Process System” filed Dec. 19, 2003.

### STATEMENT REGARDING FEDERALLY SPONSORED RESEARCH AND DEVELOPMENT

None.

### BACKGROUND OF THE INVENTION

In food processing facilities it is a day to day practice to sort out produced goods according to certain attributes like color, weight shape etc. Typically after determining the attributes of an object the produced goods are packed out according to the value of the measured attributes. Apparatuses and methods for determining attributes of food items require that a single food item be removed from a bulk loading system at a first location, placed on a conveyor at a second location, and then moved via the conveyor to a device for measuring the attribute, such as a scale. Once an attribute is measured for an item, a computer connected to the attribute measuring device has to immediately determine as to where that item will be placed. This determination commonly is based on a statistical model (such as a bell curve). Flipper devices are then used to knock the item off of a conveyor belt into the location determined by the computer.

One practice used in food processing facilities, is to arrange items (such as chicken parts) into multiple containers of equal weight, such as one pound each. When arranging items into multiple containers of an equal weight, one difficulty encountered with product separation systems, is that the practice of making an immediate determination as to where to place an item after measuring the item based on a statistical model is less accurate than desired. Making an immediate position decision using statistics can make it quite difficult to fill each container with items totaling the exact weight desired (i.e. one pound each). This is due to the fact that the products delivered in bulk do not follow a standard bell-curve spread. Another difficulty encountered by product separation systems is that each container has to be filled within a certain period of time. In other words, a container cannot be waiting indefinitely until the part with exact matching attributes comes by.

Specifically, if the desired weight of a container is one pound, and a container already contains 0.75 pounds of chicken parts, and a part is weighed at 0.38 pounds, the computer will probably place that part in the 0.75 pound container based on a prediction that a part weighing exactly 0.25 (or at least closer to 0.25 pounds) pounds will not move across the scale by the time it is necessary to remove the container that is being filled. This method yields a container that is over-packed to 1.13 pounds instead of one pound. This over-packing situation will likely result in a monetary loss to the processing facility which sells the container at a price based on a one pound weight. While it is also possible that containers could be under-packed (i.e. weigh less than one pound) the systems of most food processing facilities attempt to prevent this situation, as customers do not accept under-packed containers, whereas, they are happy to accept over-packed containers. For a facility making thousands of packages a day, the resulting loss on an annual basis is staggering.

### BRIEF SUMMARY OF THE INVENTION

There is, therefore, provided in the practice of the invention a method and apparatus for product separation and processing in a food processing facility.

In accordance with one aspect of the present invention, a method of product separation and processing is provided which includes presenting a plurality of objects in bulk; singulating an object from the plurality of objects; determining an object weight value; storing the object weight value; moving the object onto a conveyor where the conveyor has a plurality of objects on the conveyor with stored object weight values associated with the object positions; determining a position of the object on the conveyor; storing the position of the object; associating the position of the object with the object weight value; choosing a set of objects from the conveyor based on stored object weight values that most closely match a pre-defined target weight when combined; and grouping the set of objects using the object positions associated with the object weight values.

In accordance with another aspect of the invention, a method of product separation and processing is provided which includes the steps of: singulating an object from a plurality of objects; measuring an attribute of the object; placing the object among a population of previously placed objects; determining the position of the object; associating the object attribute with the object position; recording the object attribute and the object position in a database that includes the object attribute and object position for each object in the population of previously placed objects; selecting a combination of objects with combined object attributes that satisfy the desired criteria from the database; and moving objects whose object position is associated with the selected object attributes to a container.

In accordance with yet another aspect of the invention a method of separating and processing bulk product into subsets that match a pre-selected value is provided which includes the steps of: singulating an object from a plurality of objects onto a first conveyor; measuring an attribute of the object to determine an attribute value; moving the object onto a position in a second conveyor where the second conveyor includes a plurality of positioned objects; determining object coordinates that correspond to the object position; associating the object coordinates with the attribute value; adding the attribute value and object coordinates to a database which includes object coordinates and attribute values for each of the plurality of positioned objects on the second conveyor; selecting attribute values that match the pre-selected value when combined; and grouping the positioned objects whose object coordinates are associated the selected attribute values.

In accordance with an embodiment of the invention a system for product processing is provided which includes: a separation means for separating an object from a plurality of objects; an attribute measurement means for measuring an attribute of an object; a first conveyor means for distributing the object onto a second conveyor means wherein the second conveyor means is oriented perpendicularly to the first conveyor means and the second conveyor means includes a plurality of objects; a position determination means for determining the position of the object on the second conveyor means; and a controller means for storing the object attribute and the position of each of the plurality of objects and determining a combination of objects whose combined attribute measurement most closely matches a pre-selected attribute measurement value and using a pick/place unit to group the combination of objects into a container.

According to another embodiment of the invention an apparatus for sorting and grouping objects is provided which includes an attribute measurement device; a first conveyor moving at a first rate of speed; a second conveyor oriented perpendicularly to the first conveyor and moving at a second rate of speed which is less than the first rate of speed; a position determination device; and a controller unit that groups sets of objects matching a target attribute based on attribute measurements and position information from a population of objects.

According to yet another embodiment of the invention an apparatus for sorting and grouping objects is provided which includes: a singulator; a high speed conveyor with product attribute measurement device; a low speed conveyor on which products are positioned in known locations and associated with a measured attribute for each product; a controller; and a grouping device.

Accordingly, it is an object of the present invention to provide an improved method and apparatus for product separation and processing. There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims. Further features of the present invention will become apparent to those skilled in the art to which the present invention relates from reading the following description with reference to the accompanying drawings, in which:

FIG. 1 is a top view of a product separation process system according to an embodiment of the invention.

FIG. 2 is a front perspective view of a product separation process system according to an embodiment of the invention.

FIG. 3 is rear perspective view a product separation process system according to an embodiment of the invention.

### DETAILED DESCRIPTION OF THE INVENTION

The invention is described with reference to the drawing figures, in which like reference numerals refer to like parts throughout. The inventive system and method provide a way and system to process objects by measuring an object attribute, and storing that attribute with the coordinates of the object for a large number of objects to form a population of objects. The system controller can work with actual attribute values and create optimal subsets of objects from the population which most closely match a target object attribute when combined. Containers are not packed until an entire set of objects having desired individual and combined attributes has been identified. A benefit of the inventive system and method is that it is possible to pack containers with the set of objects from the object population that most closely meets or matches a target attribute value. Thus, it does not over-pack unless absolutely necessary. Another feature of the present inventive system and method is that the likelihood of over-packing is reduced using actual attribute values with multiple objects to choose from. Another benefit is that the precision of the system increases as the size of the object population increases.

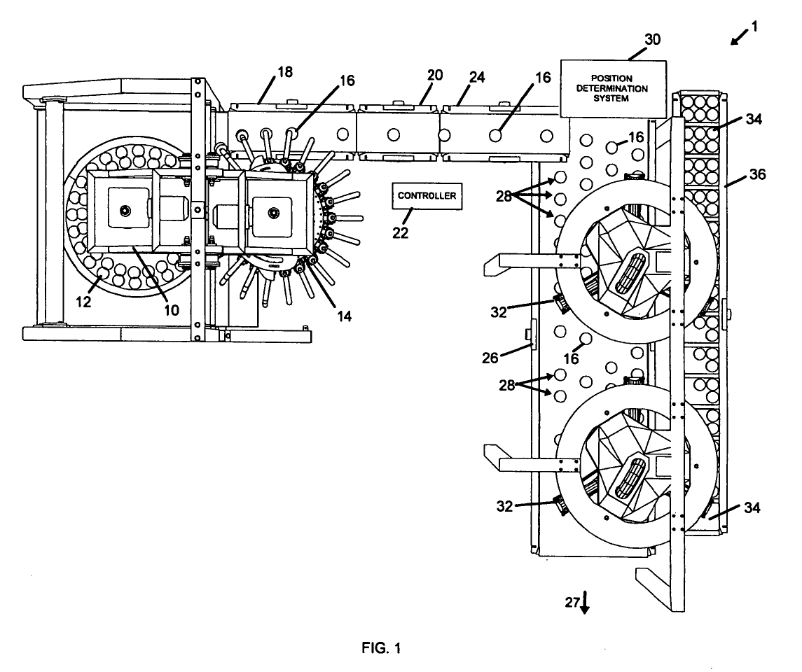

Turning now to the figures, FIG. 1 shows a top view of a product separation system 1 according to an embodiment of the invention. The product separation system 1 includes a product delivery station 10 with bulk products 12, a product transfer station 14 for transferring objects 16, a product distribution conveyor 18, an attribute measurement device 20, a system controller 22, an extendable and retractable (extend/retract) conveyor 24, a population conveyor 26 for transporting and storing an object population 28, a position determination system 30, one or more pick and place (pick/place) units 32, one or more containers 34, and a takeaway conveyor 36.

In operation, bulk products 12, such as apples or chicken parts, are supplied to the product delivery station 10 via a conveyor or some other delivery means. Other examples of bulk products 12 handled by the system may include regular or irregular shapes, and have rigid, semi-rigid, or non-rigid characteristics. The product transfer station 14 separates the bulk products 12 from the product delivery station 10 into individual objects 16, and places the objects 16 on the product distribution conveyor 18. The product distribution conveyor 18 moves the objects 16 across an attribute measurement device 20 where an attribute of the object 16 is measured and the measurement is stored in memory of the system controller 22.

The extend/retract conveyor 24 is located at the end of the product distribution conveyor 18 opposing the product transfer station 14. The extend/retract conveyor 24 moves the objects 16 in the same direction as the product distribution conveyor 18. The extend/retract conveyor 24 extends and retracts to place objects 16 at various positions along the width of the population conveyor 26. According to one embodiment, the population conveyor 26 moves at a slower rate of speed and is positioned at an angle, perpendicularly in the embodiment shown, to the product distribution conveyor 18 and the extend/retract conveyor 24. The perpendicular orientation and difference in speed between the product distribution conveyor 18 and the population conveyor line 26 produces an object population 28 that is spaced on the population conveyor 26 and moving in the direction 27 shown. In a perpendicular configuration, objects 16 are placed on the moving population conveyor 26 to form slightly arced or curved rows. In embodiments where the extend/retract conveyor 24 is tilted at an angle with respect the population conveyor 26, the angle configuration permits the extend/retract conveyor 24 to place objects 16 on the population conveyor 26 in rows that are substantially perpendicular to the direction of the population conveyor. In another embodiment, the portion of the extend/retract conveyor 24 facing the population conveyor 26 is narrowed, thereby permitting specific positioning of objects 16 onto the population conveyor 26.

A position determination system 30 sends the position coordinates of each object 16 placed on the population conveyor 26 to the controller 22 which associates those position coordinates with the previously measured attribute of each object 16. The controller 22 then selects a set of objects 16 from the entire object population 28 that best match a pre-defined value when combined. The controller 22 tracks the objects that have been selected for the set that are moving across the population conveyor 26 for combination into a single container 34. The pick/place units 32 are then used to group the objects 16 by picking up the objects 16 from the population conveyor 26 and placing the objects 16 in containers 34 moving across the takeaway conveyor 36.

In one embodiment, the product transfer station 14 includes an automatic singulator as described in U.S. patent application Ser. No. 60/576,832, incorporated herein by reference. Other embodiments include any suitable device for separating bulk product 12 into individuals objects 16 such as devices using vacuum heads, piercing arms, gripper arms, and frozen tip pickup apparatuses. It will be appreciated that the direction, tilt, position, and speed of the conveyors (18, 24, 26) of the system can be varied, and that the invention and inventive method may be practiced using a fewer number or a larger number of conveyors than shown. For example, according to one embodiment, more than one takeaway conveyor 36 may be used. It will also be appreciated that the direction that the population conveyor 26 is moving may be the same or opposite to that of the direction of the takeaway conveyor 36.

Because the controller 22 has an object population 28 made up of multiple objects 16 from which to choose, it is possible to select a set of objects from the object population 28 that most closely match a pre-selected attribute value. For example, if the weight of the object is the measured attribute, then the controller 22 will determine an optimal subset of objects 16 from the object population 28, so that the combined weight of the subset of objects 16 will most precisely match a pre-selected weight to be packed into each container 36. According to another embodiment, the position determination system 30 also sends the orientation of each of the objects 16 in the object population 28 to the controller 22. This allows the controller 22 to use the pick/place unit 32 to place objects 16 in the containers 34 in a neat or aesthetically pleasing arrangement.

In one embodiment, the attribute measurement device 20 is a weigh deck conveyor. In other embodiments, the attribute measurement device 20 is camera positioned near the product transfer station 14 to capture an image of the shape and color of the object 16 being transferred for comparison with reference files in a computer or the controller 22 to confirm the acceptability or to determine grading of the object 16 for grouping into optimal subsets of objects 16 based on shape, color, temperature, texture, or some combination thereof. In yet another embodiment, the product transfer station 14 is equipped with an apparatus for measuring the reflectance of the object 16 being transferred or with a calorimeter to enable the measurement of color or surface quality attributes of the object 16 being transferred. Other embodiments may include a pressure sensor attribute measurement device to contact the object 16 to determine the resistance of the object 16 being transferred. Other embodiments may include a temperature sensor to determine the temperature of the object 16 being transferred.

According to an embodiment, the controller 22 is a programmable computer. Other embodiments may use a PLC device or any suitable controller system or mechanism. It will be appreciated that in addition to storing the position coordinates and an attribute of the objects 16 in the object population 28, the controller 22 also tracks the relative positional coordinates of each of the objects 16 in the object population 28 to compensate for the movement of the population conveyor 26. Once a set of objects 16 has been grouped into a container 34, the controller 22 removes all of the object attribute and position information associated with each of the objects of that set, from the population database and adds information about new objects 16 to the database as they are placed on the population conveyor 26. Additionally the controller 22 coordinates the operation of the pick/place units 32 for picking up the individual objects 16 selected for a container 36 when multiple units are used. It should be noted the controller 22 may be placed in any suitable location.

In some embodiments, the system may include a single pick/place unit 32, whereas other embodiments may include multiple pick/place units 32. It will be appreciated that, in some cases, the throughput of the system decreases with use of a single pick/place unit 32. In the case where multiple pick/place units 32 are used, the controller 22 puts the selected objects 16 into a selected container 34 by using the pick/place units 32 in a coordinated, concerted fashion. An example might have the controller 22 directing multiple pick/place units 32 so that a first pick/place unit 32 puts a part of the first set of selected objects 16 in a container 34 and a second pick/place unit 32 completes the set by putting the remaining objects 16 in the set in the container 34. According to an embodiment, the pick/place units 32 are parallel arm, high speed picking and placing robots capable of handling approximately 90 items per minute. It will be appreciated, however, that any suitable device may be used.

According to another embodiment, the position determination system 30 is a vision system. Other embodiments may use a camera, radar, lidar, ultrasound, sound waves, infrared sensors, calculations based on conveyor speeds and known positions, or other suitable systems for determining the position of an object. According to another embodiment, the position determination system 30 is positioned in close proximity to the pick/place units 32, so that the position of the object 16 may be determined prior to the object 16 passing a pick/place unit 32.

According to one embodiment, a stationary staging area, such as a platform, is used in place of the population conveyor 26. In this embodiment, objects 16 are placed on the staging area via a transfer mechanism. Those skilled in the art will appreciate that the transfer mechanism could be a pick/place unit, a pivotable extend/retract conveyor, pickup arm, or any suitable device that is capable of moving an object 16. Additionally, it will be appreciated that the objects may arranged on the staging area in a number in a grid pattern, however, any suitable arrangement may be used.

In one embodiment, the container 34 is a tray. It will be appreciated that the container 34 could also be a pallet, carton, wax paper, or any suitable device capable of having one of more objects 16 placed on it.

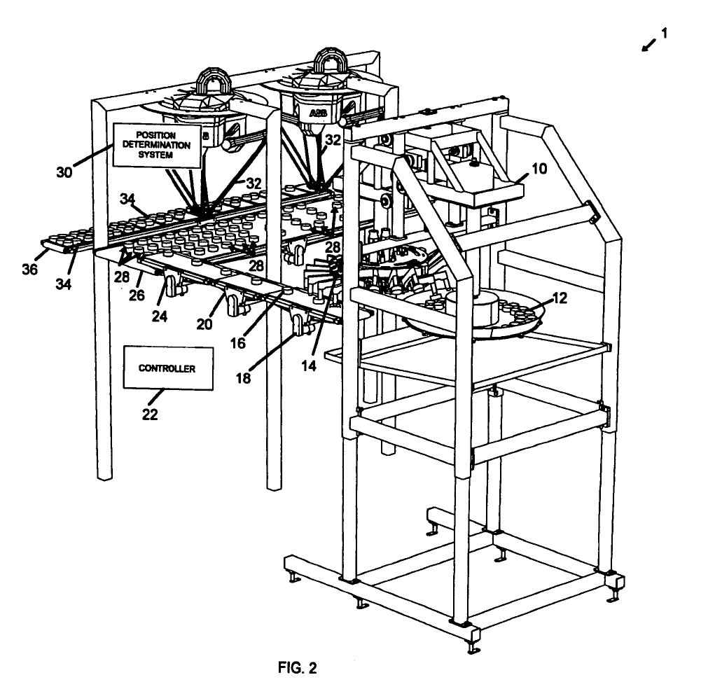

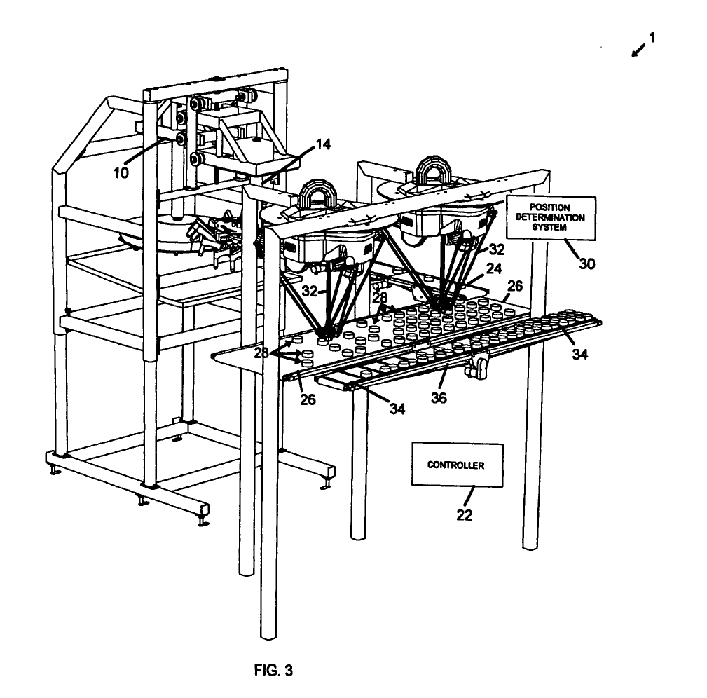

FIG. 2 is a front perspective view and FIG. 3 is a rear perspective view of the product separation process system 1 according to an embodiment of the invention. The product separation system 1 includes the product delivery station 10 supplying bulk products 12, the product transfer station 14 for transferring objects 16, the product distribution conveyor 18, the attribute measurement device 20, the system controller 22, the extendable and retractable (extend/retract) conveyor 24, the population conveyor 26 transporting and storing an object population 28, the position determination system 30, one or more pick and place (pick/place) units 32, one or more containers 34, and the takeaway conveyor 36.

From the above description of embodiments of the invention, those skilled in the art will perceive improvements, changes and modifications. Such improvements, changes and modifications within the skill of the art are intended to be covered by the appended claims.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A method of product separation and processing comprising:
singulating an object from a plurality of objects;
measuring an attribute of the object;
placing the object among a population of previously placed objects;
determining the position of the object;
associating the object attribute with the object position;
recording the object attribute and the object position in a database that includes the object attribute and object position for each object in the population of previously placed objects;
selecting a combination of objects with combined object attributes that satisfy the desired criteria from the database; and
moving objects whose object position is associated with the selected object attributes to a container.

2. The method according to claim 1 further comprising the step of removing from the database, the object attributes and associated object positions for the objects moved to the container.

3. The method according to claim 1 wherein the measured object attribute is the color of the object.

4. The method according to claim 1 wherein the measured object attribute is the shape of the object.

5. The method according to claim 1 wherein the population of previously placed objects are on a conveyor.

6. A method of product separation and processing comprising:
presenting a plurality of objects in bulk;
singulating an object from the plurality of objects;
determining an object weight value;
storing the object weight value;
moving the object onto a conveyor where the conveyor has a plurality of objects on the conveyor with stored object weight values and associated object positions;
determining a position of the object on the conveyor;
storing the position of the object;
associating the position of the object with the object weight value;
choosing a set of objects from the conveyor based on stored object weight values that most closely match a pre-defined target weight when combined; and
grouping the set of objects using the object positions associated with the object weight values for each object in the set of objects.

7. The method according to claim 6 further comprising the step of removing the object weight values and associated object positions for the grouped set of objects from the plurality of stored weight values and associated object positions.

8. The method according to claim 6 further comprising:
removing the object weight values and associated object positions for the grouped set of objects from the plurality of stored weight values and associated object positions; and
storing the object weight value and associated object position for objects moved onto the conveyor during the step of grouping the set of objects.

9. A method of separating and processing bulk product into subsets that match a pre-selected value comprising:
singulating an object from a plurality of objects onto a first conveyor;
measuring an attribute of the object to determine an attribute value;
moving the object onto a position in a second conveyor where the second conveyor includes a plurality of positioned objects;
determining object coordinates that correspond to the object position;
associating the object coordinates with the attribute value;
adding the attribute value and object coordinates to a database which includes object coordinates and attribute values for each of the plurality of positioned objects on the second conveyor;
selecting attribute values that match the pre-selected value when combined; and
grouping the positioned objects whose object coordinates are associated with the selected attribute values.

10. The method according to claim 9 further comprising the step of removing the object attribute values and associated object coordinates for the grouped set of positioned objects from the database.

11. The method according to claim 9 further comprising:
removing the object attribute values and associated object coordinates for the grouped set of positioned objects from the database; and
adding the object attribute values and associated object coordinates for objects moved onto a position on the second conveyor during the step of grouping the set of positioned objects.

12. A product processing system comprising:
a separation means for separating an object from a plurality of objects;
an attribute measurement means for measuring an attribute of an object;
a first conveyor means for distributing the object onto a second conveyor means wherein the second conveyor means is oriented perpendicularly to the first conveyor means and the second conveyor means includes a plurality of objects;
a position determination means for determining the position of the object on the second conveyor means; and
a controller means for storing the object attribute and the position of each of the plurality of objects and determining a combination of objects whose combined attribute measurement most closely matches a pre-selected attribute measurement value and using a pick/place unit to group the combination of objects into a container.

13. The apparatus for claim 12 wherein the position determination means is at least one of: a camera, radar unit, an ultrasound system, a sound wave system, or an infrared sensor system.

14. The apparatus of claim 12 wherein the attribute measurement means is at least one of: a temperature sensor, a pressure sensor, reflectometer, a calorimeter, a weigh deck, or a camera.

15. The apparatus of claim 12 wherein the side of the first conveyor means facing the second conveyor means is narrower than the portion facing the separation means.

16. The apparatus of claim 12 wherein the second conveyor means is wider than the first conveyor means.

17. An apparatus for sorting and grouping objects comprising:
an attribute measurement device;
a first conveyor moving at a first rate of speed;
a second conveyor oriented perpendicularly to the first conveyor and moving at a second rate of speed which is less than the first rate of speed;
a position determination device; and
a controller unit that groups sets of objects matching a target attribute based on attribute measurements and position information from a population of objects.

18. The apparatus of claim 17 further comprising a grouping unit.

19. The apparatus of claim 17 wherein the attribute measurement device is at least one of: a temperature sensor, a pressure sensor, reflectometer, a calorimeter, a weigh deck, or a camera.

20. The apparatus for claim 17 wherein the position determination device is at least one of: a camera, radar unit, an ultrasound system, a sound wave system, or an infrared sensor system.

21. The apparatus of claim 17 wherein the second conveyor is wider than the first conveyor.

22. An apparatus for sorting and grouping objects comprising:
a singulator;
a high speed conveyor with product attribute measurement device;
a low speed conveyor on which products are positioned in known locations and associated with a measured attribute for each product;
a controller; and
a grouping device.

23. The apparatus of claim 22 wherein the grouping device is a parallel arm picking and placing robot.

24. The apparatus of claim 22 further comprising an additional grouping device.

25. The apparatus of claim 22 further comprising a position determination device.

26. The apparatus of claim 22 wherein the low speed conveyor is wider than the high speed conveyor.
